(19) United States
(12) Patent Application Publication
(10) Pub. No.: US 2008/0258633 A1
(43) Pub. Date: Oct. 23, 2008

(54) BUILDING OPTIMIZATION SYSTEM AND LIGHTING SWITCH

(76) Inventor: Keith Voysey, Yorba Linda (CA)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/033,831

(22) Filed: Feb. 19, 2008

Related U.S. Application Data
(60) Provisional application No. 60/901,955, filed on Feb. 16, 2007.

(51) Int. Cl. G05B 11/01; H05B 37/02

(52) U.S. Cl. 315/159; 700/17

(57) ABSTRACT

A building optimization system for optimizing an environment of a building is disclosed. The building optimization system includes a number of building optimization switches for controlling the environment of a corresponding space in a building according to a plurality of operation modes. The environment at least includes first and second lighting banks. Each building optimization switch includes first and second lighting controls for manually operating corresponding first and second lighting banks, and a wireless transceiver for receiving input signals from and transmitting environment data to a master controller via a wireless communication network. Each building optimization switch further includes logic responsive to input signals from the first and second lighting controls, and/or the master controller via the wireless receiver for controlling the first and second lighting banks, and a graphical display screen adapted to display a graphical user interface by which an occupant of the building can program the building optimization switch and receive data related to each of the plurality of operation modes.

### CROSS REFERENCE TO RELATED APPLICATIONS

The present application claims priority under 35 U.S.C. §119 to U.S. Provisional Application Ser. No. 60/901,955, filed Feb. 16, 2007, entitled NETWORKED A/B CIRCUIT CONTROL LIGHTING SWITCH, the disclosure of which is incorporated herein by reference.

### BACKGROUND

This disclosure relates to lighting control switches, and more particularly to a network-capable, A/B lighting switch and control module.

A typical lighting switch for a commercial building is known as an A/B lighting switch: a wall mounted light switch that has two switches, each controlled by a manually-operated control such as a button or switch. Each switch controls an independent bank of lights (i.e. one or more lights) in an office or space (i.e. zone). Typical applications provide for one switch to control electrical current to about half of the lighting in a space or zone, and the second switch to provide electrical current to the remaining half of lighting in the same space or zone.

Conventional A/B switches can be used to reduce energy consumption, and/or control an amount of desired lighting, by allowing a user to manually activate one or the other half of the available lighting, all of the available lighting or none of the available lighting to a space. However, conventional A/B switches are “dumb” in that they rely on manual operation. Most occupants of a zone either do not care or are simply oblivious to the amount of lighting used in that zone, and therefore typically use all of the available lighting when the office is occupied, wasting significant energy.

Rising energy costs, increasingly tenuous energy supply, and accelerating environmental damage due to present energy production and consumption patterns, are just some factors that can be addressed by a needed new way to operate lighting in a building, without inconveniencing the building's occupants.

### SUMMARY

This document discloses a building optimization system, and in particular a building optimization switch, for minimizing the use of electric lighting in a building and thereby optimizing a building's energy use.

In one aspect, a building optimization switch for controlling the environment of a space in a building according to a plurality of operation modes is presented. The environment at least includes first and second lighting banks. The building optimization switch includes first and second lighting controls for manually operating corresponding first and second lighting banks, and a wireless transceiver for receiving input signals from and transmitting environment data to a master controller via a wireless communication network. The building optimization switch further includes logic responsive to input signals from the first and second lighting controls, and/or the master controller via the wireless receiver for controlling the first and second lighting banks. The building optimization switch further includes a graphical display screen adapted to display a graphical user interface by which an occupant of the building can program the building optimization switch and receive data related to each of the plurality of operation modes.

In another aspect, the building optimization switch includes a number of sensors to sense the environment data. The sensors can include a motion sensor for detecting occupancy of the space, a temperature sensor for sensing a temperature of the space, an external solar sensor for detecting an amount of external solar light being received proximate the space, and/or an external lighting sensor for detecting a light level within the space. In yet another aspect, the building optimization switch can include a mode control for receiving, from an occupant, input associated with the plurality of operation modes. The input signals can include an instruction to turn off the second lighting bank.

In still yet another aspect, a building optimization system is presented for controlling the environment of a building according to a number of operation modes. The building is composed of a number of defined spaces, and the environment at least includes first and second lighting banks in each space. The building optimization system includes a master controller for transmitting control signals via a wireless communication network to control the environment according to the plurality of operation modes. The building optimization system includes a set of building optimization switches, at least one switch per space.

The operation modes includes an ON mode in which the first and second lighting banks are in an “on” state, an OFF mode in which the first and second lighting banks are in an OFF state, at least in part responsive to the environment data, a SOLAR mode in which the first and second lighting banks are controlled according to an amount of solar light detected for the space, a DEMAND mode in which the first and second lighting banks are controlled according to peak demand levels occurring in a geographic region associated with the building, an EXIT mode in which the graphical display screen displays a message for occupants of the space to exit the building, and a SETUP mode in which selected ones of the plurality of building optimization switches receive instruction or programming data.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a high level depiction of a building optimization system for optimizing energy usage and an environment of a building.

FIG. 2 is a front view of a building optimization switch.

FIG. 3 illustrates a layout of an A/B lighting switch.

FIG. 4 illustrates one implementation of a building optimization system configuration for a building.

FIGS. 5A-D illustrate various states of an ON mode.

FIGS. 6A-B illustrate various states of an OFF mode,

FIGS. 7A-C illustrate various states of a SOLAR mode.

FIGS. 8A-B illustrate various states of a DEMAND mode.

FIG. 9 illustrates an EXIT mode.

FIG. 10 illustrates an implementation of a switch setup procedure.

FIGS. 11A-F illustrate various wiring options for the building optimization switch.

FIG. 12 shows a master controller.

FIG. 13 is a network diagram of a building optimization system including a number of master controllers networked together.

FIG. 14 illustrates a solar sensor.

Like reference symbols in the various drawings indicate like elements.

### DETAILED DESCRIPTION

This document describes a building optimization system utilizing a building optimization switch. The building optimization switch provides part of an energy savings control appliance that responds to multiple environmental and/or schedule-based conditions, including, but not limited to: 1) direct, manual override enablement of either or both of the A or B controls; 2) time of day and day of week schedule(s), which reside in a master controller; 3) occupancy state of the controlled environment as initiated by a motion sensor (the motion sensor may be incorporated with the switch, or may be wired in tandem with existing external motion detection occupancy sensor); 4) programmed peak demand requirements as mandated by utility provider schedule and power demand requirements, with programming and scheduling preferably residing with the master controller; and 5) based upon the measured ambient, direct or indirect light available (via roof sensors) the master controller determines the required light for those zones affected by ambient, direct or indirect light, and sends commands to the building optimization switch to turn lighting off accordingly.

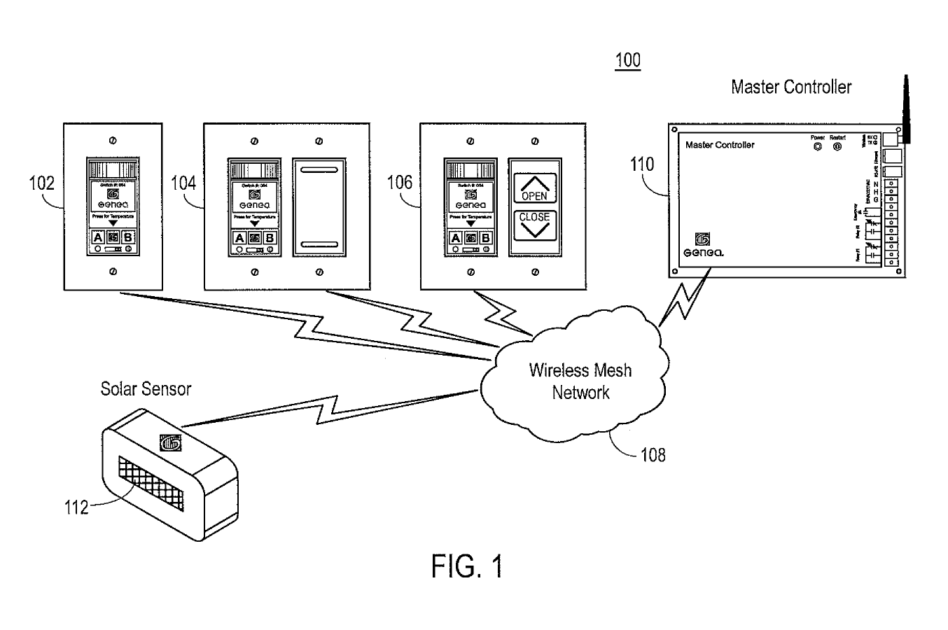

FIG. 1 is a high level depiction of a building optimization system (BOS) 100 for optimizing the energy usage of a building. The (BOS) 100 can include, without limitation and in various numbers and combinations, a building optimization (BO) switch 102, a BO switch with a sensor 104, and/or a BO switch with a blind controller 106, connected by a wireless communications network 108 to a master controller 110. The BO switch 102 is network-capable, and acts as a terminal for enabling a string of functional modules and options, such as temperature control, moisture control, and other options. The wireless communication network 108 operates using any wireless communication protocols, such as IEEE 802.15.4 or the ZigBee specification of low power digital radio communications. The BOS 100 can further include, without limitation and in various numbers and combinations, one or more solar sensors 112 for sensing solar light levels around the building. Each of these components of the BOS 100 will be described in greater detail below.

Each BO switch 102 can be contained at least partly in a physical interface made of a resilient material such as plastic, aluminum, stainless steel, or other material, and which can be mounted to the wall or other structure. The BO switch 102 also includes a power source, which is preferably derived from either direct building wiring circuitry or internal battery, and will typically be predicated on existing building wiring. The BO switch 102 is used to control the amount of electrical lighting used in a space or zone, such as an office or group of offices. Accordingly, the BO switch 102 can turn off either one, or both, lighting banks under its control, depending on such factors as user preferences, or automatically based on ambient light from harvested light. Harvested light is light that is generated by sunlight, reflected light or some other indirect, ambient lighting source, and available for use within a space or zone of a building. Each space or zone is monitored by a A/B lighting control system and controlled to allow harvested light to be adequate or even maximized, to reduce the electrical lighting requirements of the space or zone being monitored.

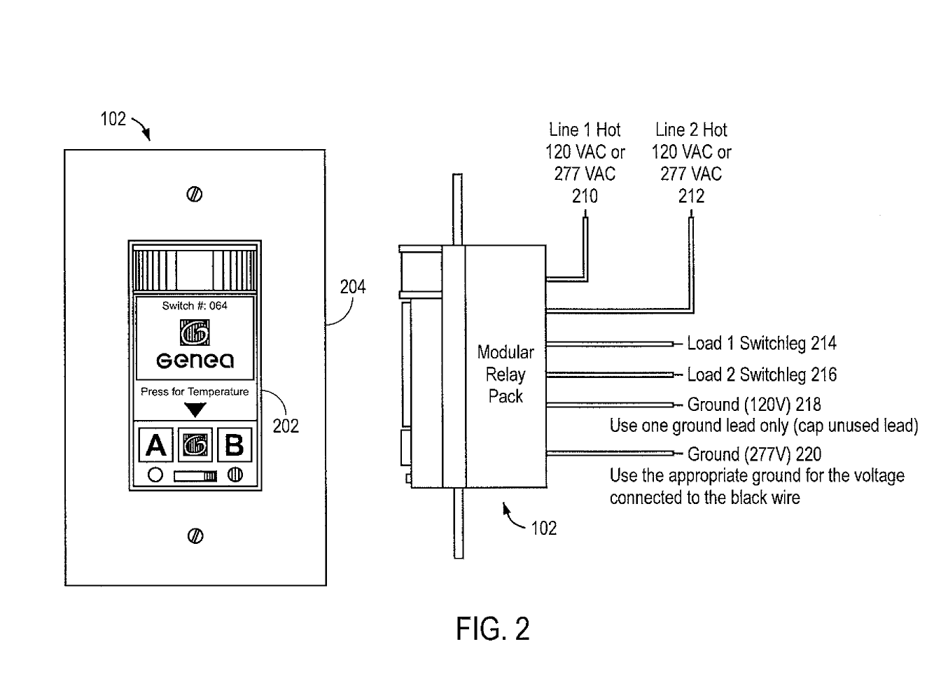

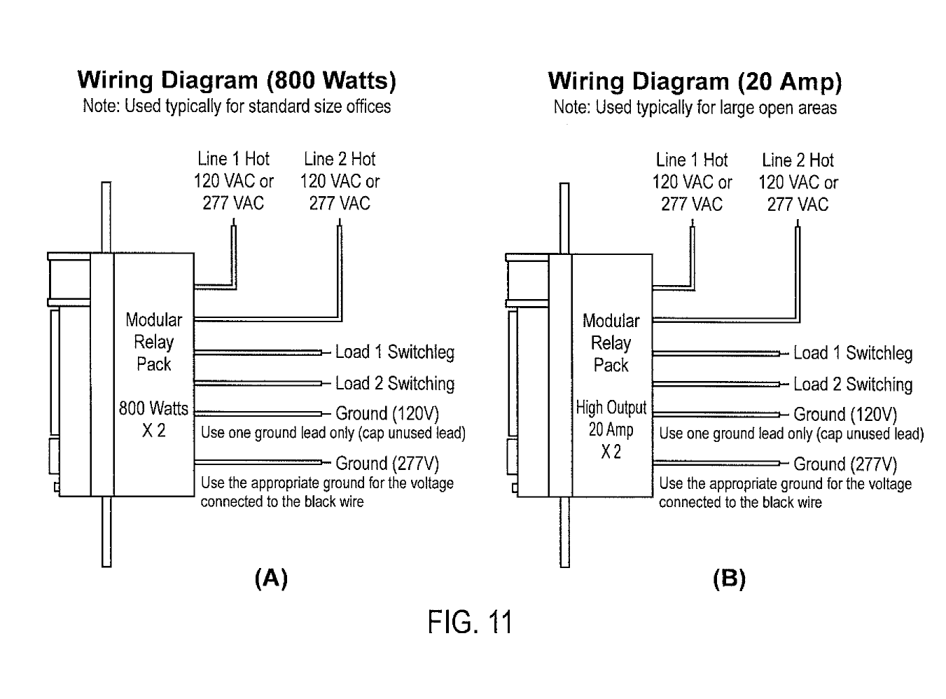

FIG. 2A is a front view of a BO switch 102 that includes an A/B lighting switch 202 and cover plate 204. FIG. 2A is a side view of the A/B lighting switch 202 that can be installed in a wall or other surface of an office or other area of a building. The A/B lighting switch utilizes standard light switch electrical power, and as such includes a line 1 hot wire 210, line 2 hot wire 212, load 1 switchleg wire 214, load 2 switchleg wire 216, a 120V ground wire 218, and a 277V ground wire 220. These wires are preferably connected to the back of the A/B lighting switch 202 via a modular relay pack 222, FIGS. 11A-F illustrate various alternative wiring diagrams.

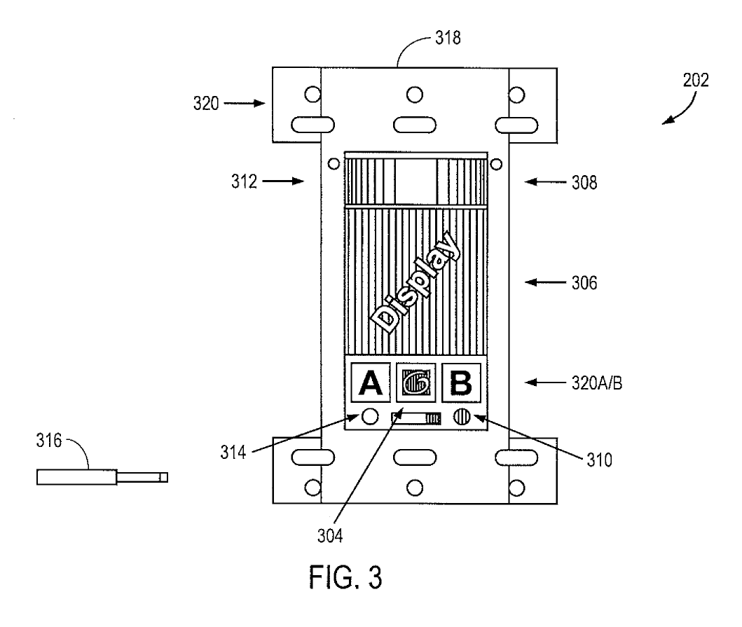

FIG. 3 depicts and illustrates a layout of an A/B lighting switch 202, that is adapted for being powered by conventional lighting power, and which includes a wireless transceiver (not shown) for transmission of environmental information of an office or area, such as lighting levels, temperature, occupancy, etc., to the master controller, and for receipt of control signals from the master controller to control various environmental aspects of the office or area, such as lighting, temperature, window blinds, etc. The wireless transceiver is adapted to communicate wirelessly with the master controller or various other components.

The A/B lighting switch 202 includes A and B lighting controls 302A and 302B, respectively. Each control controls a corresponding bank of lights within an office, area or zone in a building. In most conventional commercial buildings, the office, area or zone will include only two independent and separate banks of lights, but more than two banks of lights can be used. Accordingly, the A/B lighting switch 202 may include more lighting controls than just the A and B lighting control buttons, labeled as such herein for simplicity and clarity. The lighting controls 302A and 302B are preferably spring-activated buttons, or touch sensitive regions on the A/B lighting switch 202, and can be backlit with a light of a particular color or set of colors that are dependent on a state of the lighting bank. For example, each lighting control 302A and/or 302B can be backlit with a green light to indicate an “on” state of the corresponding lighting bank, and backlit with a white light, or not lit at all, to indicate an “off” state of the corresponding light bank. Those having skill in the art would recognize that any color or type of light can be used to indicate such states, and that any lighting source may be used, such as light emitting diodes (LEDs), incandescent lights, or other lights.

The A/B lighting switch 202 further includes a mode control 304, preferably proximate the lighting control 302A and 302B as depicted in FIG. 3. The mode control 304 can be used by a user to control certain modes or states of a lighting, temperature, moisture, or other building optimization control system, as will be described in further detail below. The mode control 304 can also be backlit with different color lights to indicate different modes. The mode control 304 as well as lighting controls 302A and 302B, can be used in conjunction with commands or options displayed in a screen 306. The screen 306 is preferably a color display, such as a liquid crystal display (LCD) used in handheld communication devices such as cell phones. The screen 306 displays the commands or user options in a first region, preferably near and corresponding to the lighting controls 302A/B and the mode control 304. The screen 306 can also display control and status information in the form of text and/or graphics, and can also prominently display different background colors to indicate different modes as selected at least in part by mode control 304. Such modes are described in greater detail below.

The A/B lighting switch 202 further includes a motion detector and/or light sensor 308 for detecting the presence of an occupant of an office or area. The motion detector component of the sensor 308 senses for occupancy of the office or area, and reports the occupancy information in a wireless data transmission. The motion detector component of the sensor 308 can be connected to automatically control the lighting banks directly depending on the occupancy information, or such control can be executed by the master controller as described in greater detail below. The light sensor component of the sensor 308 senses and determines a level of lighting within the office or area, which lighting can be from solar light (i.e. outside light from the position and angle of the sun relative to the office or area), ambient light in the office or area, or from the controlled lighting in the office or area. As will be discussed below, the light sensor component determines and reports lighting level information in a wireless data transmission, for use by the master controller to automatically control the operation of the A and/or B lighting banks in response to such modes as peak demand, energy savings, or solar light level. The light sensor component may also control the lighting banks directly, i.e. for high solar lighting levels, turning off the B and/or A lights automatically until the solar level decreases to a setpoint level.

In some implementations, the A/B lighting switch 202 further includes a temperature sensor 310 to sense temperature data and report temperature information to the master controller in a wireless data transmission. The sensed temperature can be displayed on screen 306 to assist a user to control the temperature in the office or area. The master controller can use the temperature information to control air conditioning and/or heating systems, including ducts and vents via mechanical control systems. The BO switch 102 preferably includes a gasket around the faceplate, to prevent the temperature sensor 310 from sensing temperature of air from inside the wall where the BO switch 102 is mounted, and instead enabling an accurate reading only of the temperature within the office or space.

The A/B lighting switch 202 can further include an override on/off switch for local hard “off,” “on” and restarting capability. In some implementations, the A/B lighting switch 202 includes a speaker 312, such as a solid state piezo sounder, for sounding out alarm, status or mode signals, or for broadcasting voice signals, received by the A/B lighting switch via its transceiver. A service port 314 can be provided on the face of the A/B lighting switch, and adapted to receive a service key interface 316 for the transfer of programming or instruction data via the service key. The service key interface 316 can include a universal serial bus (USB) interface for connecting to a laptop computer or other computing device such as a handheld computing device or desktop computer. In some implementations, when a service key interface 316 is inserted into the service port 314, the A/B lighting switch automatically enters a “service” mode, in which it can be reprogrammed, updated, or controlled from an external computing source. Accordingly, the A/B lighting switch further includes a processor and memory (not shown) for storing and executing instructions for optimizing a building.

The A/B lighting switch 202 includes a mounting bracket 318 for mounting the A/B lighting switch 202 in the space of a conventional light switch. The mounting bracket 318 includes a number of holes, each for receiving a screw to hold the A/B lighting switch 202 in place. The mounting bracket 318 can further include breakaway tabs 320 for center mounting of the A/B lighting switch 202 in the space of a conventional light switch.

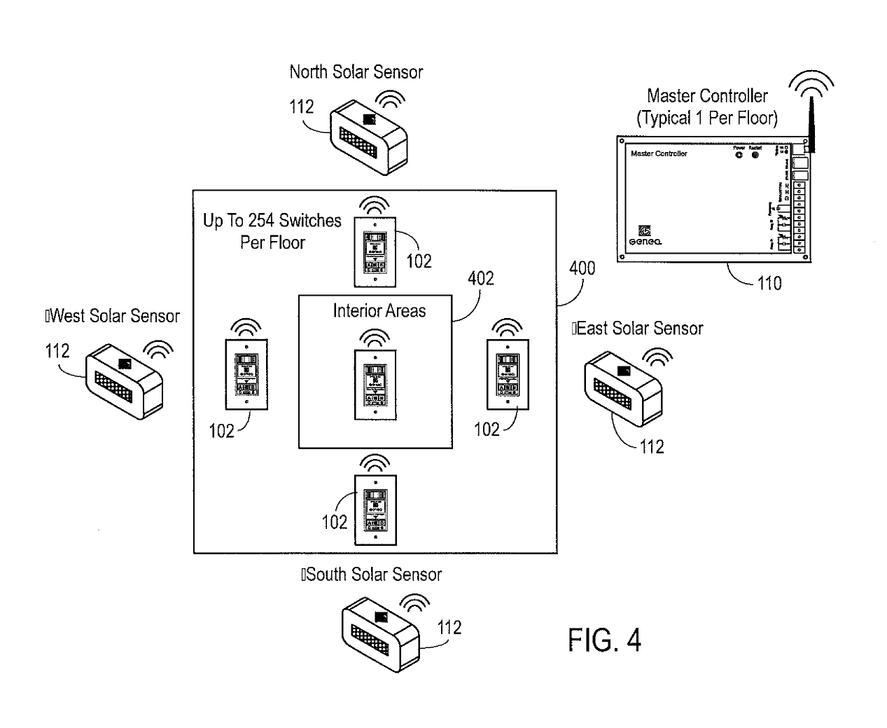

FIG. 4 illustrates one implementation of a BOS configuration for a building 400. The building is segregated into four basic segments: north, south, east and west. These orientations for the segmentation are approximate, and may represent other alignments of the building. Further, the designations of the segments can be changed based on seasonal characteristics and building shape or orientation. Other segregations are possible, such as only east and west, for example. Each segment includes a solar sensor 112 attached to an external surface of the building 400 within the segment. The solar sensor 112 senses an amount of solar light being received by the associated segment, such as full sun, partial sun, ambient light in the shade, etc. Each solar sensor 112 determines light level information from the sensed solar light, and includes a wireless transceiver or transmitter to wirelessly transmit the light level information to the master controller 110, which receives the light level information to generate control signals to control the A/B lighting switches 102 placed at various locations within the building.

In some implementations of the BOS configuration, the solar sensors 112 are installed on the top floor windows. Each floor of the building can include up to 254 A/B lighting switches 102, which includes peripheral areas as well as interior areas 402 of the building 400. In preferred implementations, each floor of the building 400 also includes only one master controller 110, however other configurations may be suitable. All of the components of the BOS configuration communicate wireless via a wireless mesh network.

The A/B lighting switches 102 can be configured for operating according to a number of different modes. Basic modes are described below, and a person of skill in the art would recognize that the names used for each mode are for illustrative purposes only, and have no limiting effect. Rather, the functionality of each mode is described under the below general titles. Further, the different modes can have combined or cross-functional capabilities.

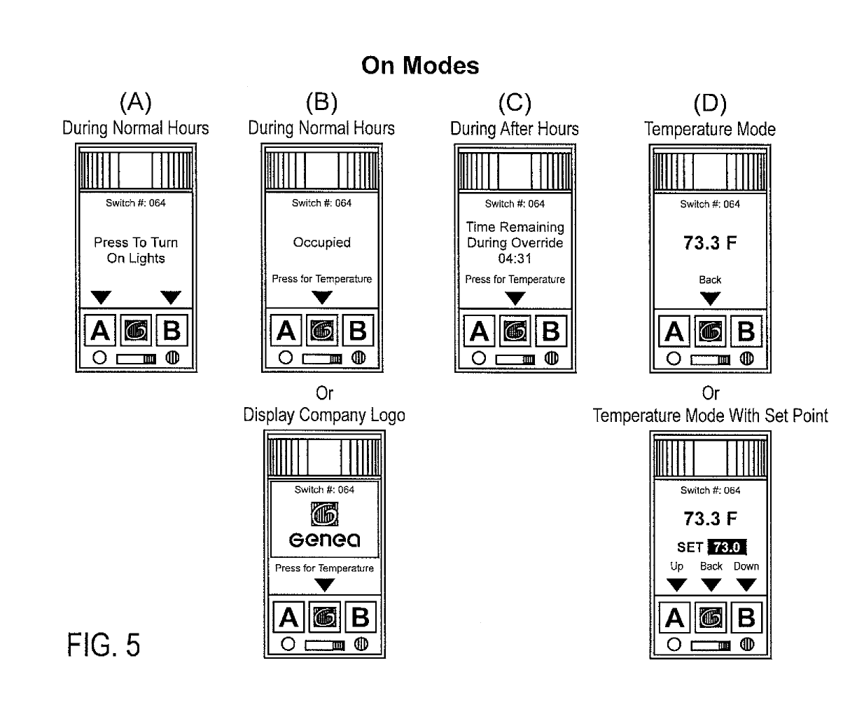

FIG. 5 illustrates various states of an ON mode. FIG. 5A shows an BO switch 102 in an ON mode during normal lease hours, typically between 8 a.m. and 6 p.m., and showing standard, manual operability of the BO switch 102 in which a user is prompted to press the “A” control and/or the “B” control to activate the corresponding lighting bank in the office or area. FIG. 5B shows a BO switch 102 during normal hours and displaying either an “occupied” mode, related to at least one person being present within the office or area and detected by the A/B lighting switch's 102 motion detector. Alternatively, the screen of the BO switch 102 can display any graphical element, such a company logo, etc. Further, the screen can display a different background color associated with each different mode, so that an occupant of a space can tell immediately from a distance which mode is currently active.

FIG. 5C shows a BO switch 102 in an afterhours state, in which the screen displays a status of the afterhours service for lighting. For afterhours service, occupants of a building can arrange to have lighting and A/C services for times outside of normal lease hours, essentially requesting an override of a shutdown of the system to conserve energy during non-lease hours. The BO switch 102 can display a time remaining during such override request (which originates from a server that controls the afterhours services), and prompt the user to activate the mode control for other information such as temperature. FIG. 5D shows a BO switch 102 in a temperature mode, in which the BO switch 102 displays on the screen a current temperature measured in the office or area, or the temperature with a set of prompts to set a desired temperature via the A and B light controls and mode control. Accordingly, the BO switch 102 can be used to adjust and control a temperature in the associated office or area. The BO switch 102 can also display a phone number or other contact information for a user to order further afterhours services.

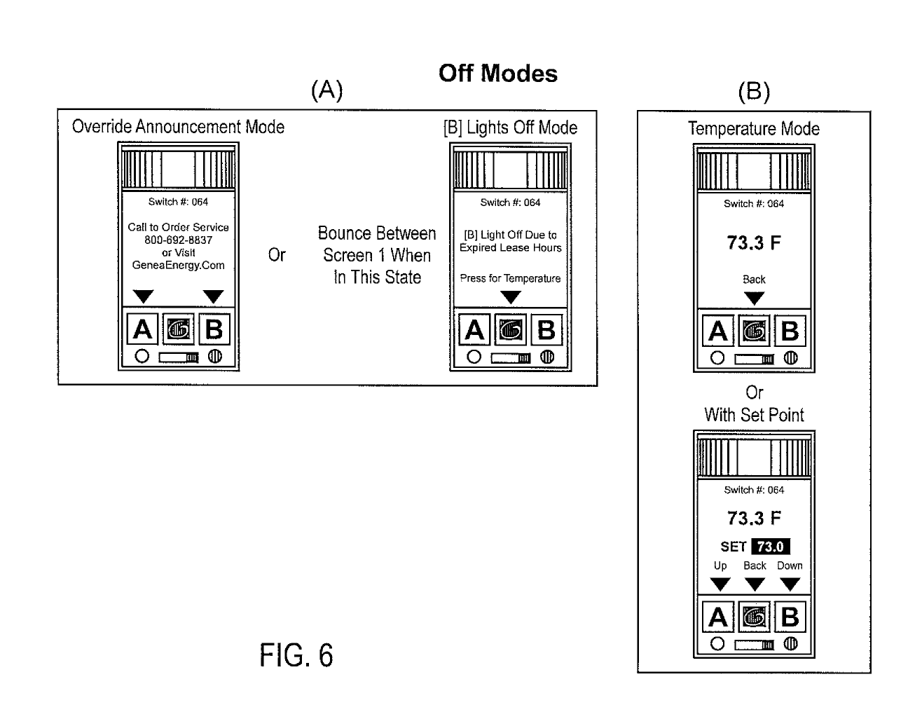

FIG. 6 illustrates various states of an OFF mode of the BO switch 102. For the OFF mode, the BO switch 102 can display a message, as shown in FIG. 6A, for a user to order service, if such service is presently unavailable due to being outside of normal lease hours, during peak energy demand periods, or other situations. For example, FIG. 6A illustrates how the BO switch 102 can display a message as to why one or more of the lighting banks are not currently operable, i.e. due to “expired lease hours.” Accordingly, in the OFF mode, a user can manipulate the A and/or B, and/or mode controls to request lighting services and control either the A or the A and B lighting banks.

FIG. 6B illustrates temperature control in an “off” state. The BO switch 102 can continue to display a temperature of an associated office or area on the screen, or can display the temperature with a set of prompts for allowing a user to set a new temperature. The set of prompts can include a temperature reading, a new temperature indicator, an “up” button to increase a number in the new temperature indicator, a “down” button to decrease the number in the new temperature indicator (preferably controlled by A and B controls, respectively), and a “back” button (preferably controlled by the mode control). Thus, even when energy systems such as lighting and/or air conditioning are turned off, the BO switch 102 enables a user to configure lighting and/or air temperature.

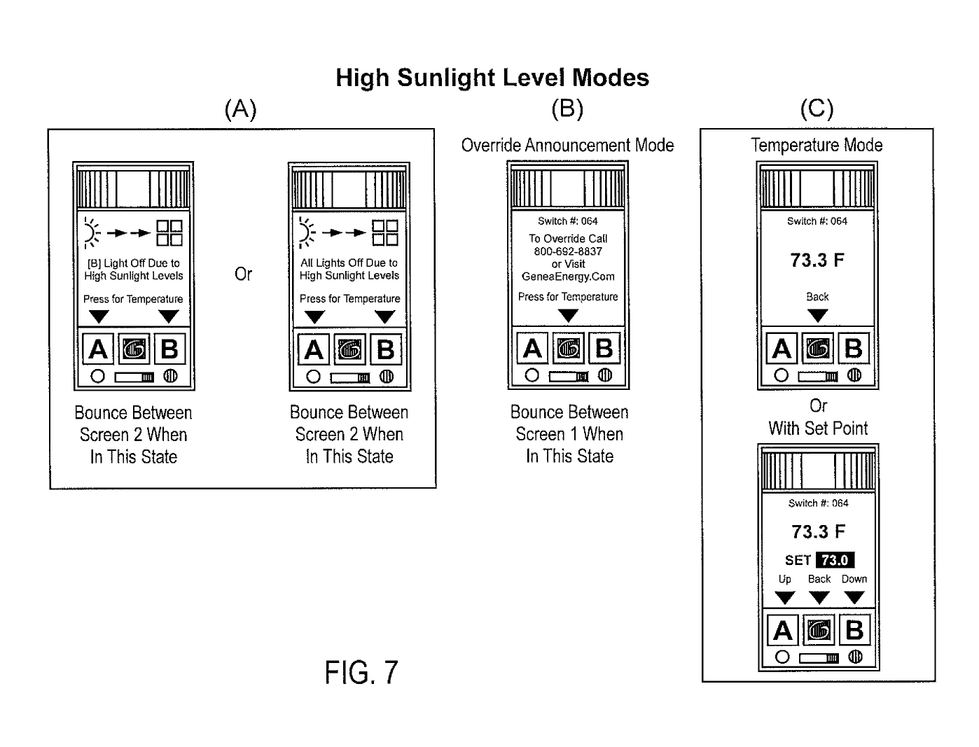

FIG. 7 illustrates various states of a SOLAR mode, in which an office or space of a building is experiencing a high amount of solar lighting. As shown in FIG. 7A, when sunlight is enough to illuminate an office or space of a building, the master controller commands the BO switch 102 to automatically turn off the “B” lighting bank of the office or space, or both “A” and “B” lights may be turned off. The BO switch 102 will display a message to inform an occupant of the office or space of such an action. If the occupant wishes to override the sunlight-based automatic shutoff of the B lights and/or A lights, the BO switch 102 may prompt the occupant with override instructions, as shown in FIG. 7B. In either state, i.e. high-sunlight shut-off or shut-off override, the mode control can be used to provide a display of room temperature, so that the occupant can control the temperature of the office or space, as will be described further below. In the SOLAR mode, the temperature can be controlled as described above with reference to FIG. 5D and FIG. 6B.

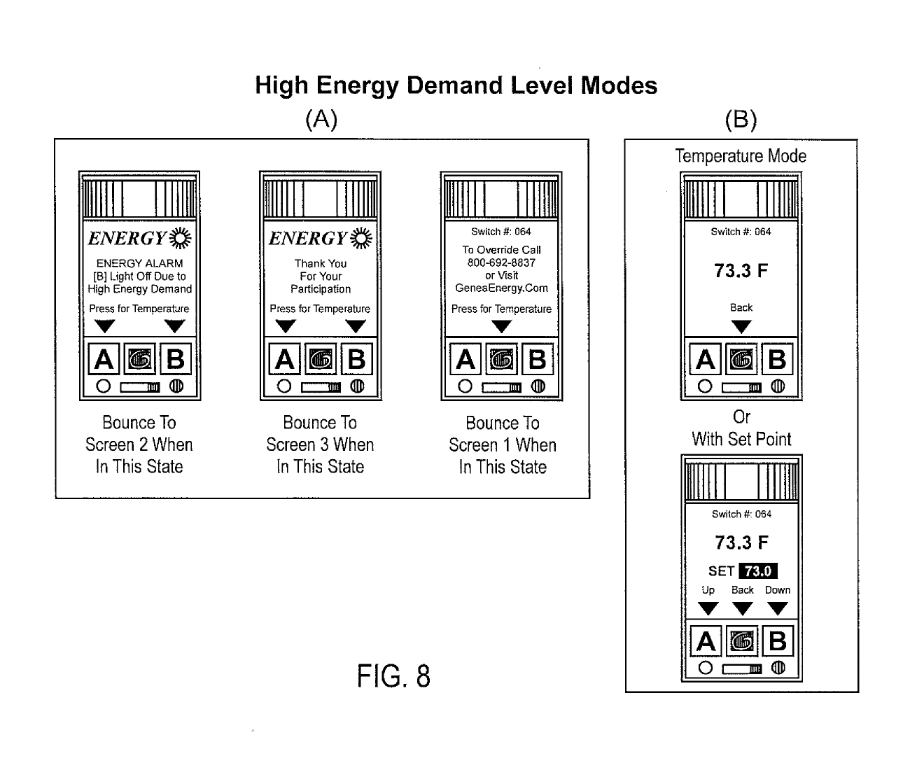

FIG. 8 illustrates various states of a DEMAND mode, in which a certain geographic region associated with the building is experiencing demand for energy services above a threshold level. In such a scenario, the master controller can instruct selected BO switches 102 to shut down associated “B” lighting banks to conserve energy. The selection as to which BO switches to instruct can be based on many factors, such as outside sunlight or orientation of an office or space, room temperature, or other factors. As shown in FIG. 8A, the BO switch 102 alternates displaying a message that lights have been turned off due to high energy demand, a message thanking the occupant for their participation, and then a message with instructions on how to override the high demand automatic shutoff. As shown in FIG. 8B, in the DEMAND mode, the temperature can be controlled as described above.

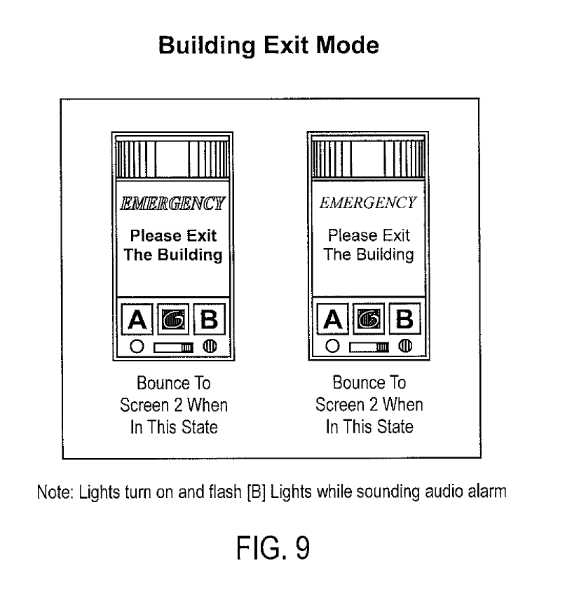

FIG. 9 illustrates an EXIT mode, in which a message is displayed informing an occupant of an emergency related to the building, and a request that the occupant exit the building. This mode may be accompanied by an audible alarm, either through the BO switch 102 or through the building's emergency broadcast system.

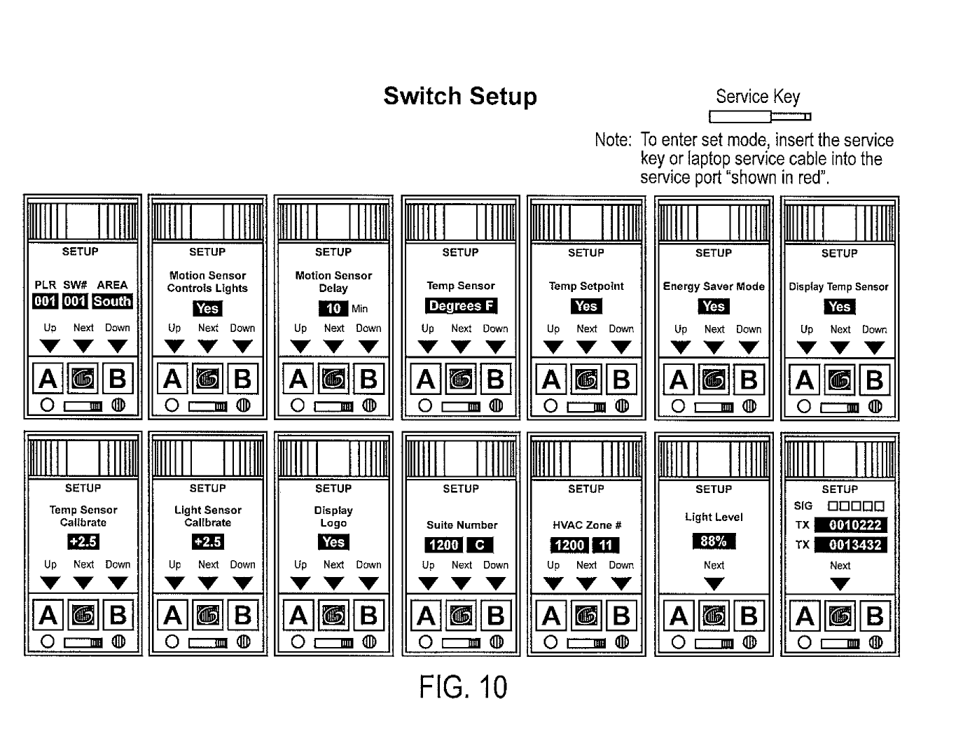

FIG. 10 is a self-explanatory illustration of an exemplary BO switch 102 setup procedure, and provides representative examples of the types of displays, text, controls and background that can be used to set up the BOS via the BO switch 102. The BO switch 102 can be used to program and set thresholds for the motion sensor, the temperature sensor, and light sensor. The office or space can also be associated with an HVAC zone, via the BO switch 102, for further temperature control.

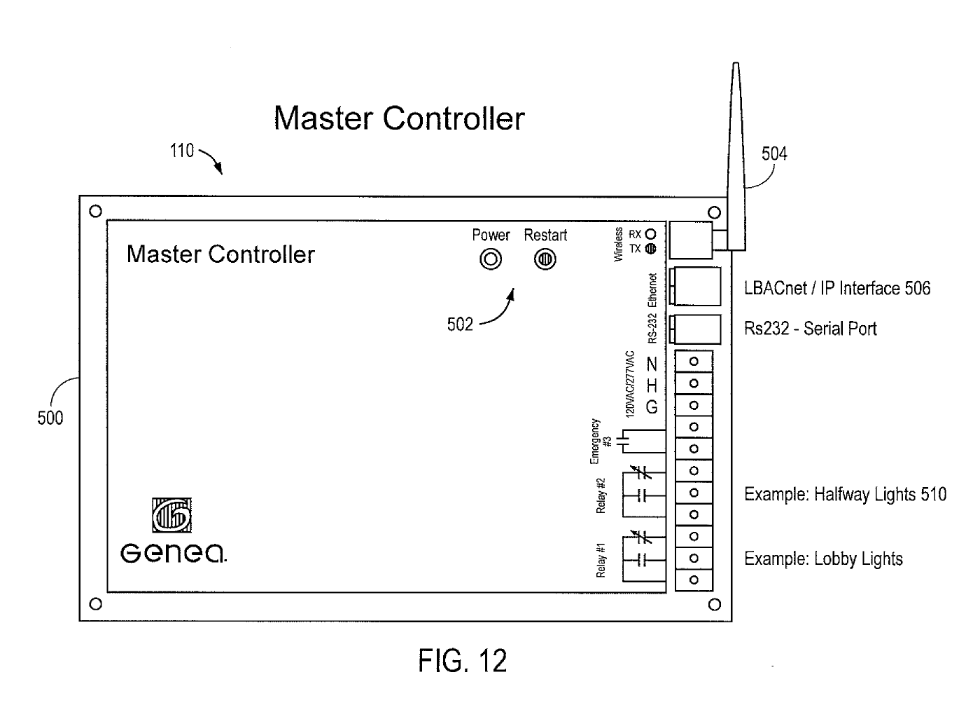

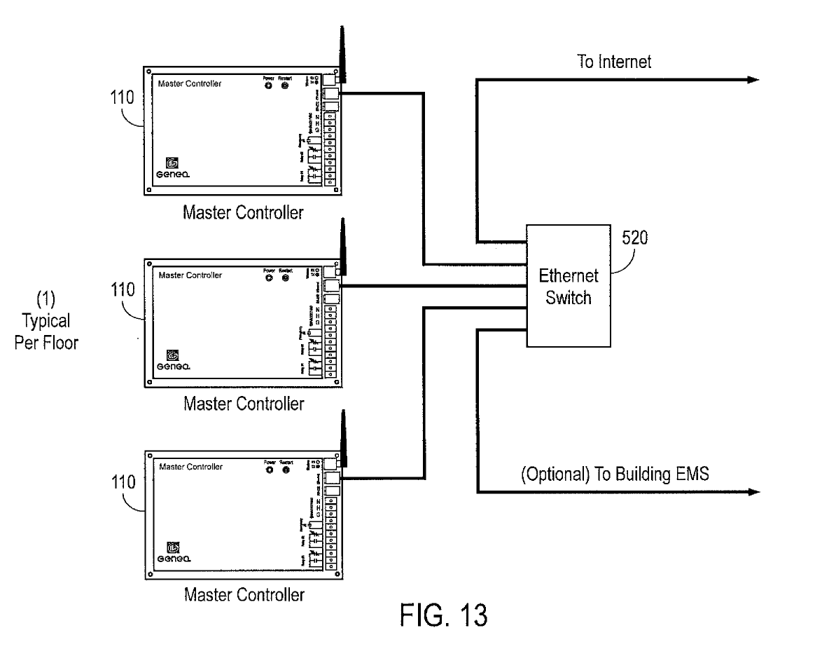

Turning now to FIG. 12, there is shown an illustration of an exemplary master controller 110. The master controller 110 can include a casing or housing 500, with indicator lights 502. The master controller 110 further includes an antenna 504 for wirelessly communicating with other components of the BOS 100, including one or more BO switches 102. The master controller 110 preferably includes an IP interface 506, such as a BACNet connection, and a serial port 508, such as an RS-232 serial port. The master controller 110 further includes one or more switches 510, 512, for controlling the operation of lights outside of a zone associated with a BO switch, such as a lobby or common hallway. A number of master controllers 110, which are preferably all associated with one building, can be connected together through a network switch 520, such as an Ethernet switch, as shown in the network diagram of FIG. 13. The network switch 520 can also connect with the Internet, and/or to the building's energy management system, i.e. a server and set of controllers for controlling lighting and/or HVAC systems.

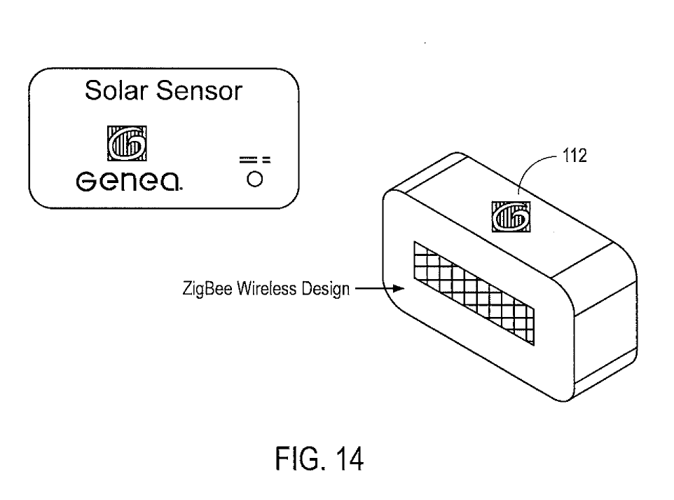

FIG. 14 shows a solar sensor 112 in greater detail. The solar sensor 112 can be attached to the outside of a building by any attachment mechanism, such as glue, screws, bolts or other attachment. The solar sensor 112 also includes at least a transmitter to transmit solar light information in the form of digital data communicated via wireless communication network. The solar light information can be used by the master controller 110 to determine whether to shut down some or all lights in areas where the sensed solar light exceeds a minimum threshold, and to then instruct the associated BO switches 102 as appropriate.

Some or all of the functional operations described in this specification can be implemented in digital electronic circuitry, or in computer software, firmware, or hardware, including the structures disclosed in this specification and their structural equivalents, or in combinations of them. Functional aspects of the building optimization system can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Implementations of the building optimization system can include a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Although a few embodiments have been described in detail above, other modifications are possible. Other embodiments may be within the scope of the following claims.

1. A building optimization switch for controlling the environment of a space in a building according to a plurality of operation modes, the environment at least including first and second lighting banks, the building optimization switch comprising:
first and second lighting controls for manually operating corresponding first and second lighting banks;
a motion sensor for detecting occupancy of the space;
a wireless receiver for receiving input signals from a master controller via a wireless communication network;
logic responsive to input signals from the first and second lighting controls, the motion sensor, and/or the master controller via the wireless receiver for controlling the first and second lighting banks; and
a graphical display screen adapted to display a graphical user interface by which an occupant of the building can program the building optimization switch and receive data related to each of the plurality of operation modes.

2. The building optimization switch in accordance with claim 1, further comprising a mode control for receiving, from an occupant, input associated with the plurality of operation modes.

3. The building optimization switch in accordance with claim 1, further comprising a wireless transmitter for transmitting status signals to the master controller.

4. The building optimization switch in accordance with claim 1, wherein the input signals include an instruction to turn off the second lighting bank.

5. The building optimization switch in accordance with claim 1, further comprising a service port adapted to receive programming or instruction data for the building optimization switch via a service key.

6. The building optimization switch in accordance with claim 1, further comprising a mounting bracket for mounting the building optimization switch in a standard lighting control faceplate.

7. The building optimization switch in accordance with claim 1, further comprising a temperature sensor for sensing a temperature of the space, the graphical display screen further configured to display the sensed temperature.

8. A building optimization switch for controlling the environment of a space in a building according to a plurality of operation modes, the environment at least including first and second lighting banks, the building optimization switch comprising:
first and second lighting controls for manually operating corresponding first and second lighting banks;
a wireless transceiver for receiving input signals from and transmitting environment data to a master controller via a wireless communication network;
logic responsive to input signals from the first and second lighting controls, and/or the master controller via the wireless receiver for controlling the first and second lighting banks; and
a graphical display screen adapted to display a graphical user interface by which an occupant of the building can program the building optimization switch and receive data related to each of the plurality of operation modes.

9. The building optimization switch in accordance with claim 8, further comprising a plurality of sensors to sense the environment data.

10. The building optimization switch in accordance with claim 9, wherein the plurality of sensors include a motion sensor for detecting occupancy of the space.

11. The building optimization switch in accordance with claim 9, wherein the plurality of sensors include a temperature sensor for sensing a temperature of the space.

12. The building optimization switch in accordance with claim 9, wherein the plurality of sensors include an external solar sensor for detecting an amount of external solar light being received proximate the space.

13. The building optimization switch in accordance with claim 9, wherein the plurality of sensors include an external lighting sensor for detecting a light level within the space.

14. The building optimization switch in accordance with claim 8, further comprising a mode control for receiving, from an occupant, input associated with the plurality of operation modes.

15. The building optimization switch in accordance with claim 8, wherein the input signals include an instruction to turn off the second lighting bank.

16. A building optimization system for controlling the environment of a building according to a plurality of operation modes, the building being composed of a number of defined spaces, the environment at least including first and second lighting banks in each space, the building optimization system comprising:
a master controller for transmitting control signals via a wireless communication network to control the environment according to the plurality of operation modes; and
a plurality of building optimization switches, at least one switch per space, each building optimization switch comprising:
first and second lighting controls for manually operating corresponding first and second lighting banks;
a wireless transceiver for receiving the control signals from the master controller, and for transmitting environment data to the master controller via the wireless communication network;
logic responsive to input signals from the first and second lighting controls, and/or the master controller via the wireless receiver for controlling the first and second lighting banks.

17. The building optimization system in accordance with claim 16, wherein each building optimization switch further comprises a graphical display screen adapted to display a graphical user interface by which an occupant of the building can program the building optimization switch and receive data related to each of the plurality of operation modes.

18. The building optimization system in accordance with claim 16, wherein the plurality of operation modes includes an ON mode in which the first and second lighting banks are in an “on” state.

19. The building optimization system in accordance with claim 16, wherein the plurality of operation modes includes an OFF mode in which the first and second lighting banks are in an OFF state, at least in part responsive to the environment data.

20. The building optimization system in accordance with claim 16, wherein the plurality of operation modes includes a SOLAR mode in which the first and second lighting banks are controlled according to an amount of solar light detected for the space.

21. The building optimization system in accordance with claim 16, wherein the plurality of operation modes includes a DEMAND mode in which the first and second lighting banks are controlled according to peak demand levels occurring in a geographic region associated with the building.

22. The building optimization system in accordance with claim 17, wherein the plurality of operation modes includes an EXIT mode in which the graphical display screen displays a message for occupants of the space to exit the building.

23. The building optimization system in accordance with claim 16, wherein the plurality of operation modes includes a SETUP mode in which selected ones of the plurality of building optimization switches receive instruction or programming data.

24. The building optimization system in accordance with claim 16, wherein the wireless communication network operates according to a ZigBee communication protocol.

25. A building optimization switch for controlling the environment of a space in a building according to a plurality of operation modes, the environment at least including first and second lighting banks, the building optimization switch comprising:
first and second lighting controls for manually operating corresponding first and second lighting banks;
a wireless transceiver for receiving input signals from and for transmitting environment data to a master controller via a wireless communication network, the wireless transceiver further configured for receiving the environment data from one or more sensors associated with the building optimization switch; and
logic responsive to input signals from the first and second lighting controls, and/or the master controller via the wireless receiver for controlling the first and second lighting banks.
